(19) United States
(12) Patent Application Publication
(10) Pub. No.: US 2003/0214164 A1
(43) Pub. Date: Nov. 20, 2003

(54) Portable outdoor seat

(76) Inventor: Jerry Gervais, Two Harbors, MN (US)

Correspondence Address: WILLIAM C. FLYNN, ATTORNEY AT LAW, P.O. BOX 74, CHANHASSEN, MN, 55317, US

(21) Appl. No.: 10/146,317

(22) Filed: May 14, 2002

(51) Int. Cl. A61H 3/04

(52) U.S. Cl. 297/273; 297/6

(57) ABSTRACT

A portable collapsible seating apparatus for attachment between lateral support members having a mechanism for seating, the seating mechanism having a plurality of elongate longitudinal straps, each of the longitudinal straps having respective ends, and a plurality of transverse stays, each of the transverse stays extending approximately perpendicular to the longitudinal straps and each transverse stray attached to each longitudinal strap so as to allow the longitudinal straps to separate by selected distance; a pair of mechanisms for end spreading, each of the end spreader mechanism attached to a respective end of each of the longitudinal straps, each end spreader means having a rigid transverse holder for holding and aligning the ends of the longitudinal straps, each transverse holder having ends; and a pair of mechanisms for attachment each attachment mechanisms attached to a respective end spreader mechanisms, each attachment mechanism attached to each end of a respective transverse holder and having a strap extending outwardly therefrom for attachment to a lateral support member.

### BACKGROUND OF THE INVENTION

The invention relates to a portable seat and more particularly, to a portable and collapsible seat designed for use in the field for outdoor activities.

People have participated in outdoor activities for as long as man has had shelter. When participating in an outdoor activity, it becomes sometimes beneficial for the person to remain in a fixed location for a lengthy period of time. An example of remaining in a fixed location would be a hunter on a stand waiting for his quarry to appear or a person fishing and waiting for the fish to bite. Or, in a simple world, a person is out of doors and just wants to stay at the location and enjoy the outdoors. In the past, the person would have to stand at the location, or sit on the ground. While sitting on the ground can be acceptable in some circumstances, it can be unacceptable in circumstances such as when the ground is wet. Also, sitting on the ground can be uncomfortable or even impossible for some people. Similarly, standing is acceptable some of the time, but, standing for too long of a time can become uncomfortable for many people.

Previously, a person would have to bring a seating device, such as a chair, with them into the outdoors when the person wanted to sit in the outdoors. While this is an acceptable solution to the problem in many circumstances, for example, sitting in one's yard or at a park, the solution becomes less acceptable when the person will be walking or hiking some distance to the location. Chairs and other conventional seating devices are not particularly portable.

There have been various attempts made to overcome the aforementioned shortcomings. Some portable seats, while being highly portable are difficult to set up for use or uncomfortable to use. Some seats have gained comfort at the expense of portability.

What is needed is a lightweight portable and collapsible seating device that can be easily carried into the outdoors and quickly and easily attached to supports for use.

### SUMMARY OF THE INVENTION

The invention herein is a lightweight collapsible sling type seat that may be collapsed for storage and transport and easily assembled and attached to field supports for use. The outdoor seat may be easily collapsed for storage and transport and taken into the field for use. Once the user is in the field and ready to use the seat may be removed from storage or transport and attached to convenient supports in the field and used for seating.

The seat provides for seating on a plurality of longitudinal support straps with the straps being allowed to separate somewhat during use to provide for more comfortable seating and air circulation about the user. The longitudinal straps are staryed in a spaced apart relationship, the spacing varying with the distance from a respective end support. This construction produces a seat that better fits the bottom of the user to provide more comfortable seating.

The longitudinal straps are attached to a spreader at each end. The spreader spreads and separates the longitudinal straps to minimize the bunching of the straps at the ends and provide a better seating shape for users of varying sizes.

It is an object of the present invention to provide an easily transportable seating device that provides comfortable seating for a user in a variety of locations.

It is an object of the present invention to provide a transportable seating device that a user may attach between a pair of supports found in the field.

It is another object of the invention to provide a seating device that may be colored to match the environment of its intended use.

It is another object of the invention to provide a seating device that may be adapted to hold accessories, such as beverage containers and the like.

It is another object of the invention to provide a seating device that has a sufficiently wide seating area to support the user without the seating area becoming so wide as to produce discomfort in the user.

It is further object of the invention to provide a seating device that supports the user with a plurality of longitudinal support straps to provide air circulation about the user.

It is further object of the invention to provide a seating device that may be used in a variety of locations and for a variety of uses while remaining readily and easily portable and storable.

The invention is a lightweight portable and collapsible seating device that can be easily carried into the outdoors and quickly and easily attached to supports for use.

### BRIEF DESCRIPTION OF THE DRAWINGS

FIG. 1 is a plan overhead view of the invention showing the invention installed for use between a pair of supports.

FIG. 2 is an enlarged partial sectional view of the invention showing the spreader mechanism.

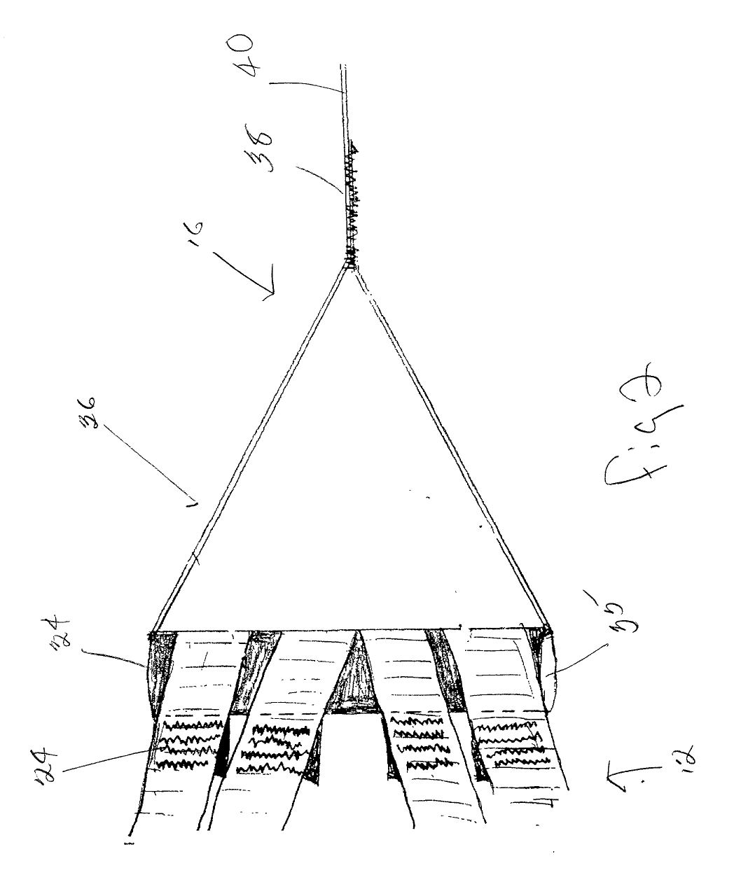

### DESCRIPTION OF THE PREFERRED EMBODIMENT

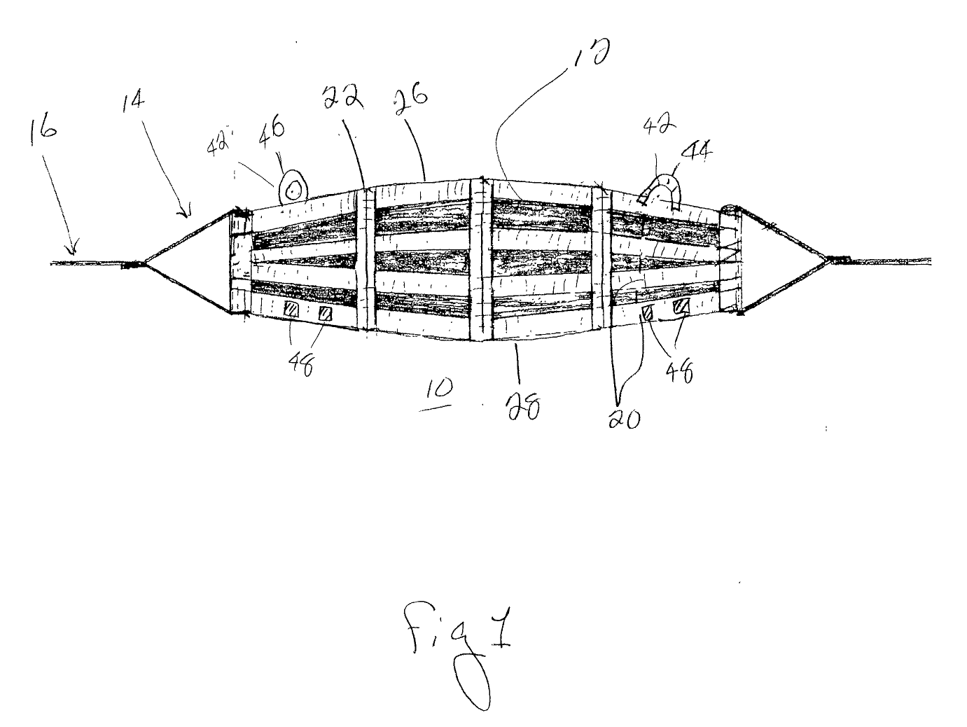

The seating sling 10 is shown in FIG. 1 attached between two supports (not shown). The seating sling 10 has a seat 12 and a pair of end harnesses 14 attached to each respective end of the seat 12. At the termination of the end harnesses 14 an attachment mechanism 16 is attached.

The seat 12 consists of multiple longitudinal straps 20 attached at each end to an end harness 14. The longitudinal straps 20 are of sufficient length to allow a user to be comfortably seated without having unnecessary length at the ends. The length will vary with the intended use, for example, a seating sling 10 intended for use by small children will obviously be shorter than a seating sling 10 intended for use by adults or two adults.

The longitudinal straps 20 may be constructed of a suitable flexible material having sufficient tensile strength to support the intended use. The longitudinal straps 20 may be formed from any suitable material, such as metal strips, woven cloth strips, flexible wood strips, or even strips of prepared tree bark, such as hickory. It is preferred that the longitudinal straps 20 be formed from readily available strips of woven synthetic fabric. The preferred synthetic fabric is nylon or polyester. The properties of nylon and polyester include the needed strength and flexibility and these fabrics are available in a multitude of colors and patterns, so that, for example, the longitudinal straps may be colored a bright color for recreational use where being seen is important or be colored a camouflage pattern for use when hunting where not being seen is important.

Each of the longitudinal straps 20 is attached at the each end to the end harness 14. The longitudinal straps 20 may be attached to the end harnesses 14 using any suitable mechanism, including, sewing, gluing, adhering, fusing, welding, or discrete fasteners such as bolts or rivets. The preferred method of attachment using the preferred material is looping each longitudinal strap 20 around a respective end harness 14 and sewing the longitudinal strap 20 back onto itself.

The longitudinal straps 20 are located and retained in a spaced apart relationship with a plurality of transverse stays 22. Each transverse stay 22 extends from a first edge 26 of the seat 12 to the second edge 28 of the seat 12. Each transverse stay 22 is attached to each of the longitudinal straps 20.

The transverse stays 22 may be constructed from any suitable material, including the materials described for construction of the longitudinal straps 20. The transverse stays 22 may be constructed from a material that is compatible with the longitudinal straps 20 and it is preferred that transverse stays 22 be constructed from the same material as the longitudinal straps 20.

The attachment of the transverse stays 22 to the longitudinal straps 20 may be by any suitable mechanism compatible with the materials used. Examples of suitable attachment mechanisms include sewing, gluing, adhering, fusing, welding, or use of discrete fasteners such as bolts or rivets. The preferred method of attachment when used with the preferred materials is sewing 24.

The transverse stays 22 are attached to locate the longitudinal straps 20 in a spaced apart relationship. The spacing of the longitudinal straps 20 allows the formation of a lattice like structure that provides for comfortable seating and allows for ventilation and cooling air flow. The transverse stays 22 are preferred to prevent the longitudinal straps 20 from separating to such a large distance that sitting becomes uncomfortable or the user risks slipping between the longitudinal straps 20 and falling to the ground.

The use of flexible longitudinal straps 20 and flexible transverse stays 22 provides a flexible seat 12 that may be rolled, folded, or stuffed for transport and storage.

Various utility holder 42 attachments may be attached to the longitudinal straps 20 of the seat 12. One utility holder 42 is a loop holder 44 which is a length of strap attached at one end to a longitudinal strap 20 and selectively attachable to the longitudinal strap 20 at its other end. Another utility holder 42 is a cup holder 46 that may be attached similarly to a longitudinal strap 20. The two utility holders 42 are intended to be examples and not to limiting, it is understood that other utility holders 42 may be fabricated for other specific uses.

In a first embodiment of the utility holder 42, the utility holder 42 is fixedly attached to the seating sling 10 and the utility holder 42 or holders 42 is attached at manufacture and cannot be change by a user as shown in FIG. 1 with the utility holders attached to the seat first edge 26.

In a preferred embodiment, the utility holders 42 are selectably attachable to the seat 12. The utility holders may be attached using any suitable mechanism for selective attachment such as, buttons, snaps, tying, or hook and loop fasteners. It is preferred to use hook and loop fasteners, such as those sold under the trademark Velcro®. In this embodiment, pads 48 of either the hook or the loop portion of the fastener are attached to a longitudinal strap 20, as shown in FIG. 1. The various utility holders 42 are fabricated having pads of the mating portion of the hook and loop fastener attached. A user may select the desired utility holders 42 for purchase and attachment at his convenience. The selected utility holders 42 may then be selectively attached to service the current uses and needs.

Located at each end of the longitudinal straps 20 is an end harness 14. Each end harness 14 has a spreader mechanism 34 attached to the attachment strap 16. The spreader mechanism 34 may be any suitable structure that spreads and separates the longitudinal straps 20 locating the longitudinal straps 20 in a substantially fixed relationship to adjacent longitudinal straps 20.

The spreader mechanism 34 may be a spreader bar 35 formed from a suitable material. The spreader bar 35 may be formed from a material having the properties of sufficient strength to support a user, and sufficient rigidity to not deform significantly. Suitable materials include wood, metal, and polymers such as polyvinyl chloride or other rigid polymers. The spreader bar 35 may be a solid bar or may be cylindrical in shape, and it is preferred that the spreader bar 35 be a tube of polyvinyl chloride.

An attachment mechanism 16 has a loop 36 attached to the spreader mechanism 34 and an elongate mounting line 40 that extends outwardly therefrom. The attachment mechanism may be constructed from any suitable material having the properties of tensile strength and flexibility. Suitable materials include various straps or cables, either wound or woven fabricated from either metal, or fibers. The preferred materials include nylon and polyester, fabricated into either straps or cylindrical cord.

The attachment mechanism 14 is affixed t to the spreader bar 35 using a suitable method. When the spreader bar 35 is solid, it is preferred to form holes in each end of the spreader bar 35 and attache the attachment mechanism therethrough. With the preferred tubular spreader bar 35, the attachment mechanism 14 may incorporated into the mounting line 40 and attached be merely passing the end of the mounting line 40 through the spreader bar 35 and binding the mounting line back onto itself using a suitable mechanism for attachment, such as binding 38.

The mounting lines 40 may be any suitable elongate material, including cording or strapping constructed of any of a variety of materials including metals or fibers, either naturally occurring or man made. The preferred material for the mounting lines 40 is the same material as the longitudinal straps 20. The use of the same material allows for economies in fabrication and matching of color or pattern between the longitudinal straps 20 and the mounting lines 40.

In its use, a user will transport the seating sling 10 to a desired location and remove the seating sling 10 from any transport packaging that is contained in. The user selects a desired location, selecting two suitably spaced supports, such as trees, poles, or any other substantially immovable supports.

Once the seating sling 10 is opened, the mounting lines 40 are each attached to a respective support. The mounting lines 40 are typically attached to the supports by wrapping the mounting lines 40 around the support and tying a knot in the mounting line 40 to tie the mounting line 40 back onto itself. However, it may be advantageous to add a mechanical fastener (not shown), such as a buckle, near the end of the mounting line 40 to provide a simpler more positive attachment.

Once the seating sling 10 has been set up and attached to supports, it is ready for use and the user may sit and enjoy the seating sling.

A user may attach the selectably attachable utility holders 42 to the seating sling 10 at any convenient time. The selected utility holder(s) may be attached prior to use, or may be attached during use. For example, a user using the seating sling 10 for hunting may take the seating sling 10 to a suitable location and install the seating sling 10 to two suitable supports and while seated in the seating sling 10 attache a loop holder 44 to one side, placing his gun through the loop to retain the gun at his side. Similarly, a cup holder 44 may be attached to the other side to conveniently hold a cup of coffee or other beverage.

After the user is done at a location, the seating sling 10 may be removed from the supports and stored for transport.

Although the present invention has been described with reference to preferred embodiments, workers skilled in the art will recognize changes may be made in form and detail without departing from the spirit and scope of the invention.

What is claimed:

1. A portable collapsible seating apparatus comprising:
a. means for seating;
b. a pair of means for end spreader, each end spreader means attached to a respective end of the seating means; and
c. means for attachment attached to and extending from the spreader means to a terminal end.

2. The device as described in claim 1 wherein the seating means comprises a plurality of elongate straps.

3. The device as described in claim 2 wherein the seating means further comprises a plurality of transverse stays for selectively separating the plurality of elongate straps.

4. The device as described in claim 1 wherein the seating means further comprises at least one utility holder attached thereto.

5. The device as described in claim 1 wherein the seating means further comprises at least one utility holder detachably attached thereto.

6. The device as described in claim 5 wherein the utility holders are selectively attached to the seating means.

7. The device as described in claim 2 wherein the spreader means further comprises an elongate bar for attachment of the seating means.

8. The device as described in claim 6 wherein the spreader bar is tubular in shape.

9. The device as described in claim 1 wherein the attachment means is an elongate flexible line.

10. The device as described in claim 1 wherein the attachment means is an elongate flexible tape.

11. The device as described in claim 8 wherein the attachment means passed through the tubular spreader bar and is back secured to loop in the attachment means.

12. The device as described in claim 1 wherein the attachment means further comprises a mechanical fastener located proximate the terminal end of the attachment means for forming a loop thereat.

13. The device as described in claim 12 wherein the mechanical fastener is a buckle.

14. A portable collapsible seating apparatus for attachment between lateral support members comprising:
a. means for seating, the seating means having a plurality of elongate longitudinal straps, each of the longitudinal straps having respective ends, and a plurality of transverse stays, each of the transverse stays extending approximately perpendicular to the longitudinal straps and each transverse stray attached to each longitudinal strap so as to allow the longitudinal straps to separate by selected distance;
b. a pair of means for end spreading, each of the end spreader means attached to a respective end of each of the longitudinal straps, each end spreader means having a rigid transverse holder for holding and aligning the ends of the longitudinal straps, each transverse holder having ends; and
c. a pair of means for attachment each attachment means attached to a respective end spreader means, each attachment means attached to each end of a respective transverse holder and having a strap extending outwardly therefrom for attachment to a lateral support member.

15. The device as described in claim 14 wherein each transverse stray is attached to each respective longitudinal strap by sewing.

16. The device as described in claim 14 wherein the spreader means is tubular.

17. The device as described in claim 14 wherein each strap of each attachment means has an end distal the spreader means, and having a fastener located proximate the distal end.

18. The device as described in claim 17 wherein the fastener is a buckle.

19. The device as described in claim 14 wherein the seating means further comprises at least one utility holder detachably attached thereto.

20. The device as described in claim 19 wherein the utility holders are selectively attached to the seating means.
